(19) United States
(12) Patent Application Publication
(10) Pub. No.: US 2018/0270671 A1
(43) Pub. Date: Sep. 20, 2018

(54) PHYSICAL-LAYER CELL IDENTITY (PCI) SELECTION

(71) Applicant: QUALCOMM Incorporated, San Diego, CA (US)

(72) Inventors: Hem Agnihotri, Varanasi (IN); Anurag Tiwari, Hardoi (IN); Weihua Gao, San Jose, CA (US)

(21) Appl. No.: 15/460,090

(22) Filed: Mar. 15, 2017

(51) Int. Cl. H04W 24/02; H04W 64/00

(52) U.S. Cl. CPC H04W 24/02; H04W 64/003

(57) ABSTRACT

Disclosed embodiments pertain to PCI planning and selection. A base station may select a PCI value from available PCI values, where the selected PCI value may be associated with a PRS frequency that is different from PRS frequencies of neighboring base stations. For example, a base station may obtain neighbor Physical layer Cell Identity (PCI) values for neighboring cells of the base station, where each neighbor PCI value may correspond to a distinct neighbor cell of the base station. The base station may receive one or more available PCI values, and, determine, based on the available PCI values and the neighbor PCI values, whether the available PCI values comprise one or more available non-colliding PCI values. A non-colliding available PCI value may then be selected as the PCI value for the cell served by the base station when the available PCI values comprise one or more available non-colliding PCI values.

### FIELD

The subject matter disclosed herein relates to wireless network configuration, and more specifically, to techniques to support configuration of base stations in cellular networks.

### BACKGROUND

It is often desirable to know the location of a terminal such as a cellular phone. For example, a location services (LCS) client may desire to know the location of a terminal in the case of an emergency services call or to provide some service to the user of the terminal such as navigation assistance or direction finding. The terms “location” and “position” are synonymous and are used interchangeably herein.

In Observed Time Difference of Arrival (OTDOA) based positioning, a mobile station may measure time differences in received signals from a plurality of base stations. Because positions of the base stations can be known, the observed time differences may be used to calculate the location of the terminal. To further help location determination, Positioning Reference Signals (PRS) are often provided by a base station (BS) in order to improve OTDOA positioning performance The measured time difference of arrival of the PRS from a reference cell (e.g. the serving cell) and a neighboring cell is known as the Reference Signal Time Difference (RSTD). Using the RSTD measurements for two (or more usually three) or more neighbor cells, the absolute or relative transmission timing of each cell, and known position(s) of BS physical transmitting antennas for the reference and neighboring cells, the User Equipment's (UE's) position may be calculated.

PRS are transmitted by a base station in special positioning subframes that are grouped into positioning occasions. The PRS positioning occasions may occur periodically at time intervals. PRS transmitted by base stations are pseudo random Quadrature Phase Shift Keying (QPSK) sequences with shifts in frequency and time. The frequency shift, which is defined in 3GPP Long Term Evolution (LTE) Release-9, is a function of the Physical layer Cell Identity (PCI) (written as N_{ID}^{cell}). The frequency shift results in an effective frequency re-use factor of 6 and determines one of 6 possible cell frequency arrangements.

In instances where two cells share the same PCI (N_{ID}^{cell}), the PRS frequencies (also referred to herein as “PRS tones”) may collide and will no longer be orthogonal. PRS tone collision may hinder UE position determination. Therefore, in some instances, PRS may be transmitted with zero power (i.e., muted). Muting, which turns off a regularly scheduled PRS transmission, may be useful, for example, when PRS signals between different cells overlap or collide, or when the PRS signals occur at the same (or almost the same) time. For example, PRS signals from some cells may be muted while PRS signals from other cells are transmitted (e.g. at a constant power). Muting may aid signal acquisition and RSTD measurement by UEs using PRS signals that are not muted (e.g. by avoiding interference from other PRS signals that have been muted). Muting may be viewed as the non-transmission of a PRS for a given positioning occasion for a particular cell.

### SUMMARY

Disclosed embodiments pertain to a processor-implemented method on a base station, which may comprise: determining one or more neighbor Physical layer Cell Identity (PCI) values for one or more neighbor cells of the base station, each neighbor PCI value corresponding to a distinct neighbor cell of the base station; receiving one or more available PCI values; determining, based on the one or more available PCI values and the one or more neighbor PCI values, whether the one or more available PCI values comprise one or more available non-colliding PCI values; and selecting, as a PCI value for a cell served by the base station, a non-colliding available PCI value, when the one or more available PCI values comprise one or more available non-colliding PCI values.

In another aspect, a base station may comprise: a memory, and a processor coupled to the memory, wherein the processor is configured to: determine one or more neighbor Physical layer Cell Identity (PCI) values for one or more neighbor cells of the base station, each neighbor PCI value corresponding to a distinct neighbor cell of the base station; receive one or more available PCI values; determine, based on the one or more available PCI values and the one or more neighbor PCI values, whether the one or more available PCI values comprise one or more available non-colliding PCI values; and select, as a PCI value for a cell served by the base station, a non-colliding available PCI value, when the one or more available PCI values comprise one or more available non-colliding PCI values.

In a further aspect, base station may comprise: means for determining one or more neighbor Physical layer Cell Identity (PCI) values for one or more neighbor cells of the base station, each neighbor PCI value corresponding to a distinct neighbor cell of the base station; means for receiving one or more available PCI values; means for determining, based on the one or more available PCI values and the one or more neighbor PCI values, whether the one or more available PCI values comprise one or more available non-colliding PCI values; and means for selecting, as a PCI value for a cell served by the base station, a non-colliding available PCI value, when the one or more available PCI values comprise one or more available non-colliding PCI values.

Disclosed embodiments also pertain to non-transitory computer-readable media comprising executable instructions to configure a processor on a base station to: determine one or more neighbor Physical layer Cell Identity (PCI) values for one or more neighbor cells of the base station, each neighbor PCI value corresponding to a distinct neighbor cell of the base station; receive one or more available PCI values; determine, based on the one or more available PCI values and the one or more neighbor PCI values, whether the one or more available PCI values comprise one or more available non-colliding PCI values; and select, as a PCI value for a cell served by the base station, a non-colliding available PCI value, when the one or more available PCI values comprise one or more available non-colliding PCI values.

The methods disclosed may be performed, in whole, or in part, by various entities in a cellular network including one or more of: base stations, servers including Operations and Management (O&M) servers and location servers. Embodiments disclosed also relate to software, firmware, and program instructions created, stored, accessed, read, or modified by processors using non-transitory computer readable media or computer readable memory.

### BRIEF DESCRIPTION OF THE DRAWINGS

FIG. 1 shows an architecture of an exemplary system capable of providing Location Services to UE 120 including the transfer of location assistance data or location information.

FIG. 2A shows the structure of an exemplary LTE frame with PRS occasions.

FIG. 2B illustrates the relationship between the System Frame Number (SFN), the cell specific subframe offset and the PRS periodicity.

FIG. 3A shows a signaling flow diagram illustrating entities and message flows for PCI configuration according to some disclosed embodiments.

FIG. 3B shows a signaling flow diagram illustrating entities and message flows to determine neighbor cells of an evolved NodeB (eNB) according to some disclosed embodiments.

FIG. 4 shows a flowchart of an exemplary method of selecting a PCI for an eNB.

FIG. 5 shows an example illustrating PCI selection for an eNB.

FIG. 6 shows a schematic block diagram illustrating certain exemplary features of or eNB enabled to support PCI planning and selection.

FIG. 7 shows a flowchart of an exemplary method of selecting a PCI for an eNB.

Like numbered entities in different figures may correspond to one another. Different instances of a common type of entity may be indicated by appending a label for the common entity with an extra label. For example, different instances of an eNB 140 may be labeled 140-1, 140-2 etc. When referring to a common entity without an extra appended label (e.g. eNB 140), any instance of the common entity may be applicable.

### DETAILED DESCRIPTION

Disclosed embodiments support deployment of Self Organizing Networks (SON), in part, by facilitating PCI planning and configuration, automatic PCI selection, and PRS tone collision avoidance in wireless communication systems. In some embodiments, the techniques disclosed may be used to facilitate network configuration and/or reconfiguration such as when base stations are added or removed, and/or when PCIs associated with base stations (e.g. eNBs) are changed.

Disclosed embodiments also facilitate PRS tone collision avoidance between base stations thereby enabling robust UE position determination. For example, PRS tone collisions between neighboring eNBs in LTE may be decreased. Further, disclosed techniques facilitate a reduction in PRS muting, which may result in a reduction of the volume of OTDOA assistance data provided to UEs. Muting may: (a) increase PRS transmission overhead; (ii) limit PRS transmission by one or more base stations (when muted); (iii) require additional assistance data signaling (muting patterns may need to be signaled to UEs); and (iv) additional UE capability (e.g. to interpret and use muting pattern assistance information). In addition, muting patterns may require reconfiguration when PCIs are changed and/or the network is reconfigured (e.g. base stations are added/removed). Therefore, techniques to reduce PRS tone collision and improve configuration and operation of base stations in cellular networks can facilitate efficient location determination.

In instances when PRS tone collision between neighboring cells is prevented, PRS muting can be avoided. Accordingly, in the example above, OTDOA assistance data may not include muting configuration information thereby: (a) reducing the volume of OTDOA assistance data; and (b) facilitating processing of OTDOA assistance data by UEs that do not have the capability to process OTDOA assistance data that includes muting configuration or muting pattern assistance information.

The term “neighbor” or “neighboring” as used herein in relation to a first cell may refer to: (a) cells bordering the first cell; or (b) cells (which may or may not border the first cell) hearable (e.g. during a Network Listen function) by an base station (e.g. eNB) serving the first cell; or (c) cells associated with a corresponding eNB, where the corresponding eNB is connected by an X2 interface with the first cell; or (d) cells determined to be neighbor cells of the first cell by a location server (e.g. an Enhanced Serving Mobile Location Center); or (e) cells determined to be neighbor cells of the first cell based on measurements by a UE (e.g. in a UE-Automatic Neighbor Relations or UE-ANR report message) in communication with an eNB serving the first cell; or (f) a stored list of neighbor cells held by an eNB serving the first cell; or (g) some combination of the above. A “neighboring eNB” may be associated with one of the neighbor cells of the first cell.

The terms “mobile station” (MS), “user equipment” (UE) and “target” are used interchangeably herein and may refer to a device such as a cellular or other wireless communication device, personal communication system (PCS) device, personal navigation device (PND), Personal Information Manager (PIM), Personal Digital Assistant (PDA), laptop, cell phone, smartphone, tablet, tracking device or other suitable mobile device which is capable of receiving wireless communication and/or navigation signals. The terms are also intended to include devices, which may communicate with a personal navigation device (PND), such as by short-range wireless, infrared, wireline connection, or other connection—regardless of whether satellite signal reception, assistance data reception, and/or position-related processing occurs at the device or at the PND.

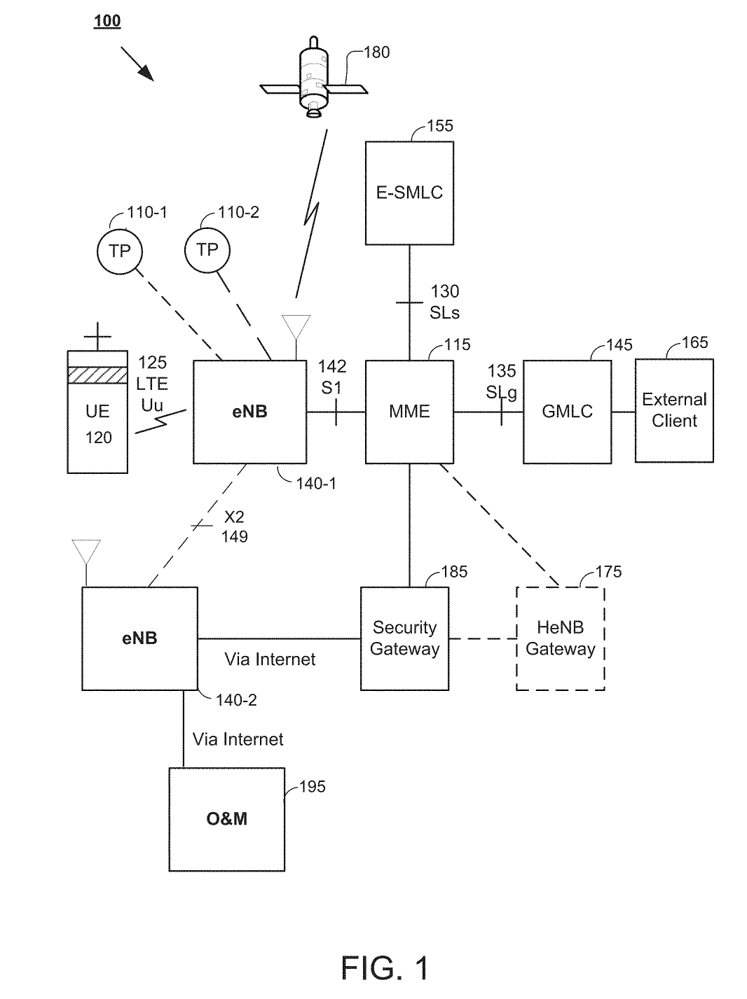

FIG. 1 shows an architecture of an exemplary system capable of providing Location Services to a UE 120 including the transfer of location assistance data or location information. System 100 may support the transfer of location assistance data or location information, using messages such as Long Term Evolution (LTE) Positioning Protocol (LPP) or LPP extensions (LPPe) messages between UE 120 and a location server (LS) such as an Enhanced Serving Mobile Location Center (E-SMLC) 155 or another network entity. Further, the LPP Annex (LPPa) protocol may be used for communication between an LS (e.g. E-SMLC 155) and an eNB 140 (e.g. eNB 140-1).

LTE is described in documents available from an organization known as the 3rd Generation Partnership Project (3GPP). In some embodiments, system 100 may form part of, comprise or contain an Evolved Packet System (EPS), which may comprise an evolved UMTS Terrestrial Radio Access Network (E-UTRAN) and an Evolved Packet Core (EPC). LPP is well-known and described in various publicly available technical specifications from 3GPP (e.g. 3GPP Technical Specification (TS) 36.355 entitled “LTE Positioning Protocol”). LPPe has been defined by the Open Mobile Alliance (OMA) (e.g. in OMA TS OMA-TS-LPPe-V1_0 entitled “LPP Extensions Specification”) and may be used in combination with LPP such that an LPP message may contain an embedded LPPe message in a combined LPP/LPPe message. LPPa is described in the publicly available 3GPP TS 36.455 document entitled “LTE Positioning Protocol A.” In general, a positioning protocol such as LPP and LPPe may be used to coordinate and control position determination. The positioning protocol may define: (a) positioning related procedures that may be executed by a location server (LS) and/or a UE; and/or (b) communication or signaling related to positioning between the LS and UE. In the case of LPPa, the protocol may be used between an LS (e.g. E-SMLC 155) and a BS (e.g. an eNB) to enable the LS to request and receive configuration information for the BS (e.g. details of PRS signals transmitted) and positioning measurements made by the BS of a UE.

In Control Plane (CP) positioning, the signaling used to initiate a positioning event and the signaling related to the positioning event occur over the control channels of the cellular network. In CP positioning, the location server may include or take the form of an Enhanced Serving Mobile Location Center (E-SMLC) 155. The architecture illustrated in FIG. 1 applies to the control plane solution.

In User Plane (UP) positioning such as Secure User Plane Location (SUPL) positioning, signaling to initiate and perform Location Based Services (LBS) functions may utilize user data channels and appear as user data. In UP positioning, the location server may include or take the form of a SUPL Location Platform (SLP). For example, the SLP may be connected to Home evolved Node B (HeNB) gateway 175.

In FIG. 1, one or more of the blocks shown may correspond to logical entities. The logical entities shown in FIG. 1 may be physically separate, or, one or more of the logical entities may be included in a single physical server or device. The transfer of the location information may occur at a rate appropriate to both UE 120 and the LS or other entity. The logical entities and block shown in FIG. 1 are merely exemplary and the functions associated with the logical entities/blocks may be split or combined in various ways in a manner consistent with disclosed embodiments. For simplicity, only one UE 120 and two eNBs 140 are shown in FIG. 1. In general, system 100 may comprise several or many UEs 120, multiple cells served by multiple eNBs 140, and additional logical entities, and Space Vehicles (SVs) 180.

In some embodiments, one or more eNBs 140 may transmit may transmit Positioning Reference Signals (PRS), which may be used for location determination. The PRS frequency is a modulo 6 function of the PCI associated with a cell served or controlled by an eNB, which results in eNBs transmitting PRS in one of six frequencies. PRS frequencies are also referred to as PRS tones herein.

In some embodiments, one or more eNBs 140 in system 100 may be optionally coupled to one or more Transmission Points (TPs) 110. For example, as shown in FIG. 1, eNB 140 may be coupled to TPs 110-1 and 110-2. In some embodiments, TPs 110 (e.g. TP 110-1 or 110-2) may act as positioning beacons and may transmit Positioning Reference Signals (PRS) after being appropriately configured by an eNB 140 (e.g. eNB 140-1). For example, a TP 110 may take the form of a physical antenna, a physical antenna element or physical antenna port (e.g. in an antenna diversity scheme), a Remote Radio Head (RRH), or a physical antenna port in a Distributed Antenna System (DAS) or a femtocell. TPs 110 may also be called a positioning beacon, eNB beacon, standalone eNB beacon, or RN beacon. In general, TP 110, as used herein, refers to all entities in a Radio Access Network (RAN) that transmit PRS to assist in positioning of one or more target UEs 120.

In some embodiments, TPs 100 may provide additional LTE/PRS coverage for indoor locations. In some embodiments, TP 110 may act as a standalone beacon that can transmit a PRS signal to support positioning of UEs and may also transmit information needed to support UE acquisition and measurement of the PRS such as an LTE master information block (MIB) and one or more LTE system information blocks (SIBs). TPs 110 may be used to deploy wireless networks in areas with poor network coverage (e.g. a basement deep inside a building) or to extend network coverage (e.g. over a large area served by a single BS). TPs 110 may facilitate both increased coverage and reliability in an area served by eNB 140. In some embodiments, eNB 140 (e.g. .eNB 140-1) may communicate over a Local Area Network (LAN) or a Wireless LAN (WLAN) (not shown in FIG. 1) with TPs 110 (e.g. TPs 110-1 and 110-2). A WLAN may be an IEEE 802.11x network. For example, eNB 140-1 may be coupled to TPs 110-1 and 110-2 over a WLAN.

As shown in FIG. 1, UE 120 may be capable of receiving wireless communication from eNBs 140 and TPs 110 over radio interface LTE-Uu 125. Radio interface LTE-Uu 125 may be used between: (a) UE 120 and eNB 140 and (b) UE 120 and TP 110. In some embodiments, eNB 140 may request neighbor cell information from UE 120 (e.g. based on measurements performed by UE 120). For example, eNB 140 may send an Automatic Neighbor Relations (ANR) report request to UE120. UE 120 may obtain measurements of neighboring cells and respond with a UE-ANR report message, which may include the Cell Global Identity (CGI) and/or PCI of neighboring cells. ANR is described in 3GPP TS 25.484 entitled “Automatic Neighbour Relation for UTRAN.” In some embodiments, neighbor eNB information such as PCI (e.g. PCI for eNB 140-2) may be obtained by eNB 140-1 via communication with neighboring eNBs (e.g. eNB 140-2), a location server such as E-SMLC 155, and/or O&M 195. In some embodiments, the neighbor cell information may be stored in a database such as a Neighbor Relations Table (NRT) on eNB 140.

In some embodiments, eNB 140 may communicate with one or more TPs 110 (e.g. via a LAN or WLAN) to provide configuration information for TPs 110, and/or to configure or reconfigure downlink (DL) signaling information in TPs 110 (e.g. information related to transmission of PRS signals). In some embodiments, eNB 140 may further communicate with an LS (e.g. an E-SMLC 155) to provide configuration information for TPs 110 (e.g. PRS configuration information for TPs 110). In some embodiments, eNB 140 may communicate with an Operations and Maintenance (O&M) system with regard to available PCIs and/or PRS signal configuration for eNB 140. In some embodiments, eNB 140 may also provide timing information to TPs 110 (e.g. GPS time information obtained using a GPS receiver associated with an eNB 140).

In some embodiments, eNB 140 may interface with an MME 115 either using a direct link (such as S1 interface 142 between eNB 140-1 and MME 115) or via a security gateway (e.g. Security Gateway 185) and possibly a Home eNodeB (HeNB) gateway (e.g. HeNB Gateway 175). When a direct link is used, eNB 140 may communicate with the MME 115 via a subset of the normal 3GPP S1 interface (defined in 3GPP TS 36.413 entitled “S1 Application Protocol”) between an MME and eNB. When a link via a security gateway 185 and optionally HeNB gateway 175 is used, eNB 140 may interface in a manner similar to HeNB 175 (e.g. using an Internet connection to access the security gateway 185).

In some embodiments, an eNB 140 may communicate with a Mobility Management Entity (MME) 115 over S1 interface 142. In some embodiments, S1 interface 142 may include an S1 CP interface and an S1 UP interface. MME 115 may support location sessions with a location server such as E-SMLC 155 to provide LCS for UE 120. In some embodiments, MME 115 and E-SMLC 155 may communicate over an SLs interface 130. UE 120 may exchange LCS-related messages (e.g. LPP and/or LPP/LPPe messages) with the E-SMLC 155 to obtain location services. The LCS-related messages may be forwarded through an eNB 140 and MME 115. In some embodiments, MME 115 may also support UE/subscriber mobility within a cell, as well as support for mobility between cells/networks.

In some embodiments, neighboring eNBs may communicate directly over X2 interface 149, which may provide functionality similar to the S1 interface. For example, when eNB 140-1 and eNB 140-2 are neighbors, eNB 140-1 and eNB 140-2 may communicate over X2 interface 149. For example, eNB 140-1 may request and/or eNB 140-2 may send PCI configuration information for eNB 140-2 over X2 interface 149. Further, eNBs 140 may also communicate via MME 115 and Security Gateway 185. In some embodiments, eNB 140 may communicate with E-SMLC 155 via MME 115. For example, eNB 140-1 may request neighbor cell information, including PCI information for neighboring cells, from E-SMLC 155. E-SMLC 155 may respond with neighbor cell information, including the PCI associated eNB 140-2.

In some embodiments, E-SMLC 155 may determine a (network based or UE-assisted) location of UEs 120. E-SMLC 155 may use measurements of radio signals such as Positioning Reference Signals (PRS) (which may be provided by a UE 120) to help determine the location of a UE 120. In some embodiments, an MME 115 may communicate with Gateway Mobility Location Center (GMLC) 145 over an SLg interface 135.

In some embodiments, a GMLC 145 may provide an interface to External Clients 165. External Clients 165 may, for example, take the form of LCS Clients, which may request a location of UE 120 to support Location Based Services (LBS). In some embodiments, GMLC 145 may support interfacing with External Clients (such as LCS clients) and include functionality required to support LBS. GMLC 145 may forward positioning requests related to UE 120 from External Client 165 to an MME 115 serving UE 120 over SLg interface 135. GMLC 145 may also forward location estimates for UE 120 to External Client 165.

In some embodiments, eNBs 140 (e.g. eNB 140-2 in FIG. 1) may alternatively be coupled to an Operations & Maintenance Server (O&M) 195, which may communicate with eNBs 140 with regard to configuration and management of eNBs 140 and/or TPs 110. For example, as shown in FIG. 1, eNB 140-2 and O&M 195 are coupled over the Internet. In some embodiments, eNB 140-2 may also be coupled to MME 115 through a Security Gateway 185. Security Gateway 185 and eNB 140-2 may be coupled over the Internet. Further, Security Gateway 185 may also be coupled to (or combined with) an HeNB Gateway 175 and enable eNB 140-2 to access MME 115 (via security gateway 185 and HeNB gateway 175) in the same manner as an HeNB which may avoid the need for a direct link between eNB 140 and MME 115. HeNB Gateway 175 may also be coupled to MME 115 and communicate with MME 115 using an S1 interface (e.g. S1 interface 142).

In OTDOA based positioning, UE 120 may measure time differences for received PRS. The measured time difference of arrival of the PRS from a reference cell (or a reference eNB or TP associated with a reference cell) and one or more neighboring cells (and/or corresponding neighboring eNBs/TPs) may be used to obtain RSTDs. The RSTDs may be used in conjunction with the known positions of eNBs (or TPs) to calculate the position of UE 120. To obtain acceptable positioning information, eNBs 140 (and/or TPs 110) participating in OTDOA may be synchronized (e.g. to within 100 ns or better). In some embodiments, eNBs 140 may have access to a GPS Clock, GPS timing, and/or to a GPS (or other Global Navigation Satellite System (GNSS)) SV 180, to facilitate synchronization. In some embodiments, time synchronization information (e.g. GPS time) may be provided to TPs 110 by an eNB 140 using, for example, the Internet Network Time Protocol (NTP), IEEE 1588 Precision Time Protocol (PTP) and/or Synchronous Ethernet.

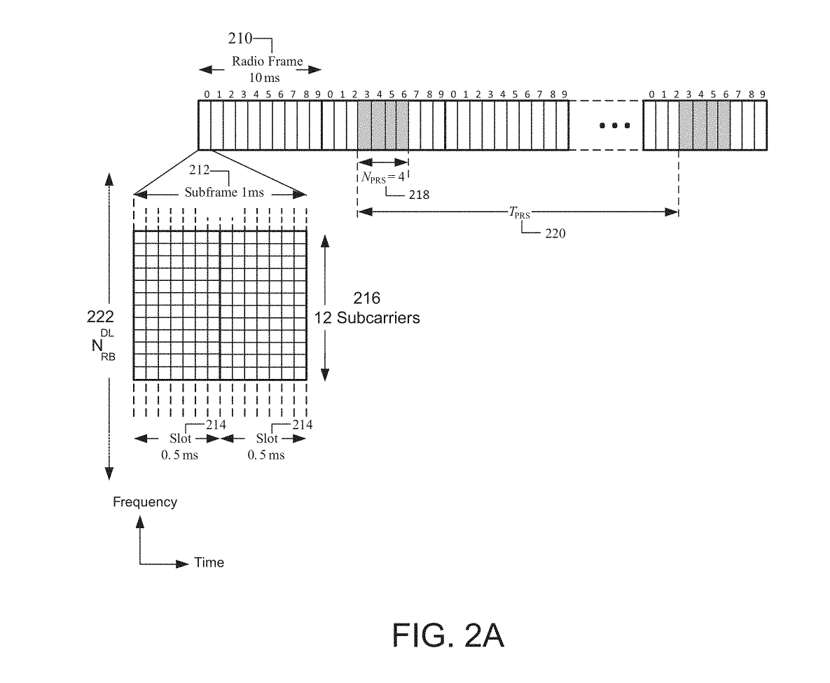

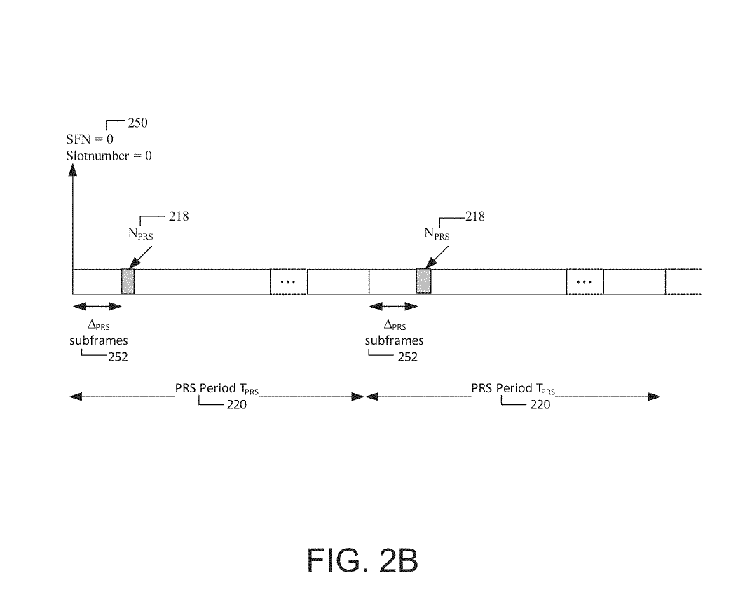

FIG. 2A shows the structure of an exemplary LTE frame with PRS occasions. In FIG. 2A, time is shown on the X (horizontal) axis, while frequency is shown on the Y (vertical) axis. PRS, which have been defined in 3GPP Long Term Evolution (LTE) Release-9, may be transmitted by eNBs 140. In some embodiments, PRS may also be transmitted by TPs 110 (e.g. TPs 110-1 and 110-2) after appropriate configuration by a controlling eNB 140 (e.g. eNB 140-1). PRS may be transmitted in special positioning subframes that are grouped into positioning occasions. The PRS positioning occasions may occur periodically at time intervals. For example, in LTE, the positioning occasion, denoted by N_{PRS}, can comprise 1, 2, 4, or 6 consecutive positioning subframes (N_{PRS} ∈ {1, 2, 4, 6}) and may occur periodically at 160, 320, 640, or 1280 millisecond intervals. In FIG. 2A, for example, the number of consecutive positions subframe N_{PRS} 218 is 4. The positioning occasions recur with some PRS Periodicity denoted by T_{PRS} 220. In some embodiments, T_{PRS} 220 may be measured in terms of the number of subframes between the start of consecutive positioning occasions.

PRS transmitted by base stations are pseudo random QPSK sequences with shifts in frequency and time. The frequency shift, defined in 3GPP Long Term Evolution (LTE) Release-9, is a function of the PCI N_{ID}^{cell} and results in an effective frequency re-use factor of 6 and determines one of 6 possible cell frequency arrangements. For example, in instances where two cells share the same PCI (N_{ID}^{cell}), the PRS tones may collide and will no longer be orthogonal. PRS tone collision may hinder UE position determination.

Within each positioning occasion, PRS are transmitted with a constant power. PRS can also be transmitted with zero power (i.e., muted). Muting, which turns off a regularly scheduled PRS transmission, may be useful when PRS patterns between cells overlap. Muting aids signal acquisition by UEs 120. Muting may be viewed as the non-transmission of a PRS for a given positioning occasion for a particular cell/TP. When muting is used, muting patterns may be signaled to UE 120. For example, a bit string may be used to signal a muting pattern, so that when a bit at position j in the bit string is set to “0,” then UE 120 may infer that the PRS is muted for the j^{th} positioning occasion. However, muting may: contribute to an increase in PRS transmission overhead; limit PRS transmission by one or more base stations (when muted); require additional assistance data signaling and UE capability (e.g. signaling of muting patterns may need to be provided to and decoded by UEs); and require reconfiguration when PCIs are changed and/or the network is reconfigured (e.g. base stations are added/removed). Therefore, limiting or decreasing muting in cellular networks can be advantageous.

To further improve hearability of PRS, positioning subframes may be low-interference subframes that are transmitted without user data channels. As a result, in ideally synchronized networks, PRSs may receive interference from other cell PRSs with the same PRS pattern index or the same PRS tone (i.e. cells transmitting PRS with the same frequency shift), but not from data transmissions. As outlined above, the frequency shift, in LTE, for example, is defined as a function of the Physical layer Cell Identity (PCI) (also written as N_{ID}^{cell}) and results in an effective frequency re-use factor of 6.

As shown in FIG. 2A, downlink and uplink LTE Radio Frames 210 are of 10 ms duration each. For downlink Frequency Division Duplex (FDD) mode, Radio Frames 210 are organized into ten subframes 212 of 1 ms duration each. Each subframe 212 comprises two slots 214, each of 0.5 ms duration.

In the frequency domain, the available bandwidth may be divided into uniformly spaced orthogonal subcarriers 216. For example, for a normal length cyclic prefix using 15 KHz spacing, subcarriers 216 may be grouped into a group of 12. Each grouping, which comprises 12 subcarriers 216, in FIG. 2A, is termed a resource block and, in the example above, the number of subcarriers in the resource block may be written as N_{SC}^{SB}=12. For a given channel bandwidth, the number of available resource blocks on each channel 222, which is also called the transmission bandwidth configuration 222, is indicated as N_{RB}^{DL} 222. For example, for a 3 MHz channel bandwidth in the above example, the number of available resource blocks on each channel 222 is given by N_{RB}^{DL}=15.

In the LTE architecture illustrated in FIG. 1, eNBs 140 (and appropriately configured TPs 110) may transmit PRS, which may be measured and used for UE position determination. OTDOA assistance data are usually provided for one or more “neighbor cells” or “neighboring cells” relative to a “reference cell.” PRS positioning by UE 120 may also be facilitated by including the serving cell in the OTDOA assistance data. For example, OTDOA assistance data may include “expected RSTD” parameters, which provide the MS information about the RSTD values the MS is expected to measure at its current location together with an uncertainty of the expected RSTD parameter. The expected RSTD together with the uncertainty defines then a search window for the MS where the MS is expected to measure the RSTD value. “Expected RSTDs” for cells in the OTDOA assistance data neighbor cell list are usually provided relative to an OTDOA assistance data reference cell. OTDOA assistance information may also include PRS configuration information parameters, which allow a UE to determine when a PRS positioning occasion occurs on signals received from various cells, and to determine the PRS sequence transmitted from various cells in order to measure a TOA.

Using the RSTD measurements, the absolute or relative transmission timing of each cell, and the known position(s) of BS physical transmitting antennas for the reference and neighboring cells, the UEs position may be calculated. RSTD for a cell “k” relative to a reference cell “Ref,” may be given as (TOAₖ−TOA_{Ref}). The time difference of arrival numbers are then converted to RSTD units, which are defined in appropriate standards/protocol documents and sent to the location server. Using (i) the RSTD measurements, (ii) the absolute or relative transmission timing of each neighboring cell, and (iii) the known position(s) of BS physical transmitting antennas for the reference and neighboring cells, the UE's position may be determined.

FIG. 2B illustrates the relationship between the System Frame Number (SFN), the cell specific subframe offset and the PRS Periodicity T_{PRS} 220. Typically, the cell specific PRS subframe configuration is defined by a “PRS Configuration Index” I_{PRS} included in the OTDOA assistance data. The cell specific subframe configuration period and the cell specific subframe offset for the transmission of positioning reference signals are defined based on the I_{PRS}, in the 3GPP specifications listed in Table 1 below.

TABLE 1
Positioning reference signal subframe configuration

| PRS configuration | PRS periodicity T_{PRS} | PRS subframe offset Δ_{PRS} |
|---|---|---|
| Index I_{PRS} | (subframes) | (subframes) |
| 0-159 | 160 | I_{PRS} |
| 160-479 | 320 | I_{PRS} − 160 |
| 480-1119 | 640 | I_{PRS} − 480 |
| 1120-2399 | 1280 | I_{PRS} − 1120 |

| | |
|---|---|
| 2400-4095 | Reserved |

PRS configuration is defined with reference to the System Frame Number (SFN) of a cell that transmits PRS. PRS instances, for the first subframe of downlink subframes, satisfy

(10×n_{f}+└nₛ/2┘−Δ_{PRS})modT_{PRS}=0, (1)

where,

n_{f} is the SFN with 0≤SFN≤1023,

nₛ is the slot number of the radio frame with 0≤nₛ≤19,

T_{PRS} is the PRS period, and

Δ_{PRS} is the cell-specific subframe offset and

mod is the modulo function, where mod (x, y) or x mod y returns the remainder of division of x by y.

As shown in FIG. 2B, the cell specific subframe offset Δ_{PRS} 252 may be defined in terms of the number of subframes transmitted starting from System Frame Number 0, Slot Number 0 250 to the start of a PRS positioning occasion. In FIG. 2B, the number of consecutive positioning subframes 218, N_{PRS}, is 4.

In some embodiments, when UE 120 receives a PRS configuration index I_{PRS} in the OTDOA assistance data, UE 120 may determine PRS periodicity T_{PRS} and PRS subframe offset Δ_{PRS} using Table 1. Upon obtaining information about the frame and slot timing i.e. the SFN and slot number (n_{f}, nₛ) for a cell, UE 120 may determine the frame and slot when a PRS is scheduled in the cell. The OTDOA assistance data is determined by E-SMLC 155 and includes assistance data for a reference cell, and a number of neighbor cells.

Typically, PRS occasions from all cells are aligned in time. In SFN-synchronous networks all eNBs are aligned on both, frame boundary and system frame number. Therefore, in SFN-synchronous networks all cells use the same PRS configuration index. On the other hand, in SFN-asynchronous networks all eNBs are aligned on frame boundary, but not system frame number. Thus, in SFN-asynchronous networks the PRS configuration index for each cell is configured by the network so that PRS occasions align in time.

UE 120 may determine the timing of the PRS occasions of the assistance data cells, if UE 120 can obtain the cell timing (e.g., SFN or Frame Number) of at least one of the assistance data cells. The timing of the other assistance data cells may then be derived by UE 120, for example based on the assumption that PRS occasions from different cells overlap.

UE 120 may obtain the cell timing (SFN) of one of the reference or neighbor cells in OTDOA assistance data in order to calculate the frame and slot on which the PRS is transmitted. For example, the cell serving UE 120 (the serving cell) may be included in the OTDOA assistance data, either as a reference cell or as an assistance data neighbor cell, because the SFN of the serving cell is known to UE 120.

Referring to FIG. 1, in some embodiments, when UE 120 requests OTDOA assistance data, or during a positioning session involving eNBs/TPCs 140 and/or TPs 110, E-SMLC 155 may communicate with eNBs 140 via MME 115 to obtain PRS configuration information for eNB 140 and/or TPs 110. In some embodiments, upon receipt of the PRS configuration information and locations for eNB 140 and TPs 110, E-SMLC 155 may provide OTDOA assistance data to a UE 120 whose location is requested. In some embodiments, E-SMLC 155 may provide the OTDOA assistance data to UE 120 using the LPP protocol. For example, E-SMLC 155 may provide the OTDOA assistance data to UE 120 using an LPP Provide Assistance Data message. An LPP Provide Assistance Data message may include OTDOA assistance data such as PRS parameters (e.g. bandwidth, PRS code, frequency, muting) for a reference cell, neighboring cells and/or neighboring TPs 110.

In some embodiments, after providing the OTDOA assistance data E-SMLC 155 may further send an LPP Request Location Information message to UE 120. In some embodiments, an LPP Request Location Information message may be used to request RSTD measurements by UE 120. For example, during UE assisted mode, UE location determination by E-SMLC 155 may be based, in part, on RSTD measurements by UE 120. In some embodiments, an LPP Request Location Information message may include: information elements such as the type of location information desired; a desired accuracy for any location estimates/measurements; and/or a response time and/or the location determination method (e.g. OTDOA) to be used.

In some embodiments, a UE 120 may perform RSTD measurements using the provided assistance data (e.g. in the earlier LPP Provide Assistance Data message from E-SMLC 155). Further, UE 120 may, within the specified response time, provide UE determined RSTD measurements in an LPP Provide Location Information message to E-SMLC 155. An LPP Provide Location Information message may include information elements such as one or more of: RSTD measurements; and/or quality metrics associated with the RSTD measurements, identity of the reference cell used for measuring the RSTDs; a quality metric related to the TOA measurements from the reference cell; a neighbor cell measurement list including identities of measured neighbor cells and measured TPs 110.

Based on the measurements received from UE 120 in an LPP Provide Location Information message, E-SMLC 155 may determine a location of UE 120 and provide the location information to MME 115, which may relay the information to External Client 165 through GMLC 145.

In a typical macro-cell scenario, the PRS configuration parameters such as the number of consecutive positioning subframes, periodicity, muting pattern, etc. may be configured by the network and may be signaled to UE 120 by E-SMLC 155 as OTDOA assistance data.

In some instances, for example with Cooperative Multi-Point (CoMP) transmission, TPs 110 may share a common PCI given by N_{ID}^{cell} (e.g. a PCI associated with the controlling eNB 140). In some instances, such as with CoMP, RRHs, DAS, and/or antenna diversity schemes, the PRS associated with TPs 110 (e.g. physical antennas) may be varied. For example, when TPs for a cell share the PCI, a function of a TP ID (e.g. physical antenna ID or physical antenna port ID) may be used to vary the PRS transmitted by that TP (or physical antenna relative to another TP or physical antenna for that cell. As one example, the initialization seed (e.g. cᵢₙᵢₜ) used to generate a PRS sequence may be varied based on the TP ID (e.g. physical antenna ID or physical antenna port ID) so that the PRS generated by each TP 110 associated with a cell is distinct. As another example, each TP 110 associated with a cell may generate a PRS sequence with a corresponding frequency shift, where the corresponding frequency shift may be based on the TP ID (e.g. physical antenna ID or physical antenna port ID).

In conventional schemes, in the examples above, when PRS tones associated with neighboring macro-cells are the same, but PRS tones for TPs in each cell are varied based on a TP ID, the likelihood of PRS tone collisions between TPs 110 associated with different neighboring cells may be increased when the TPs share a common TP ID (e.g. a physical antenna port ID). In some disclosed embodiments, the methods disclosed herein may also facilitate generation of non-colliding PRS tones by TPs.

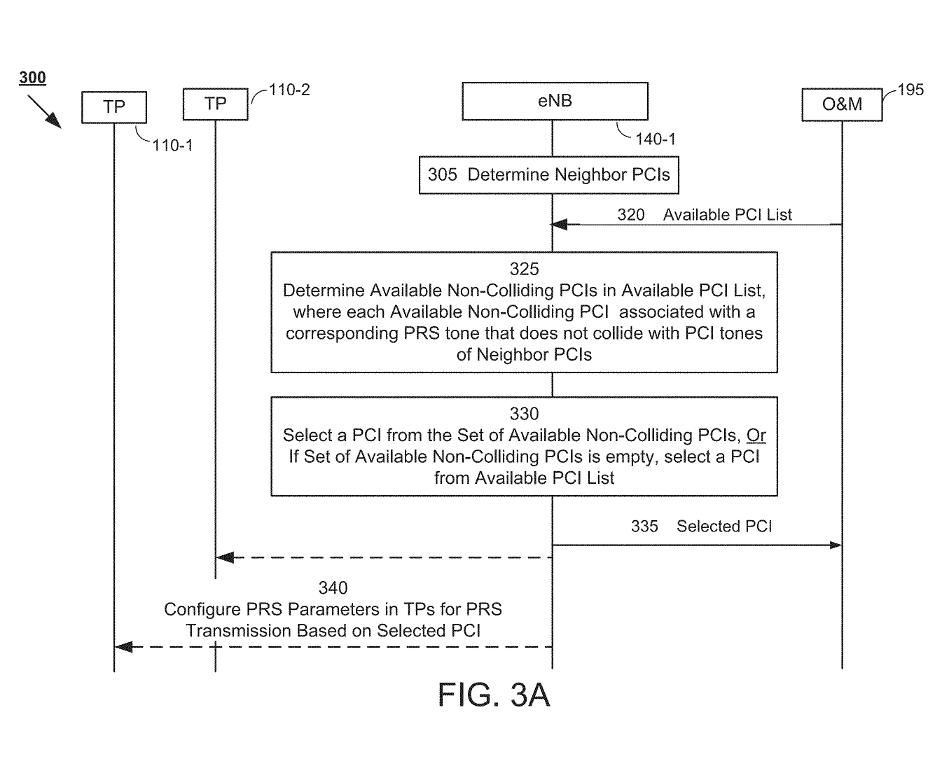

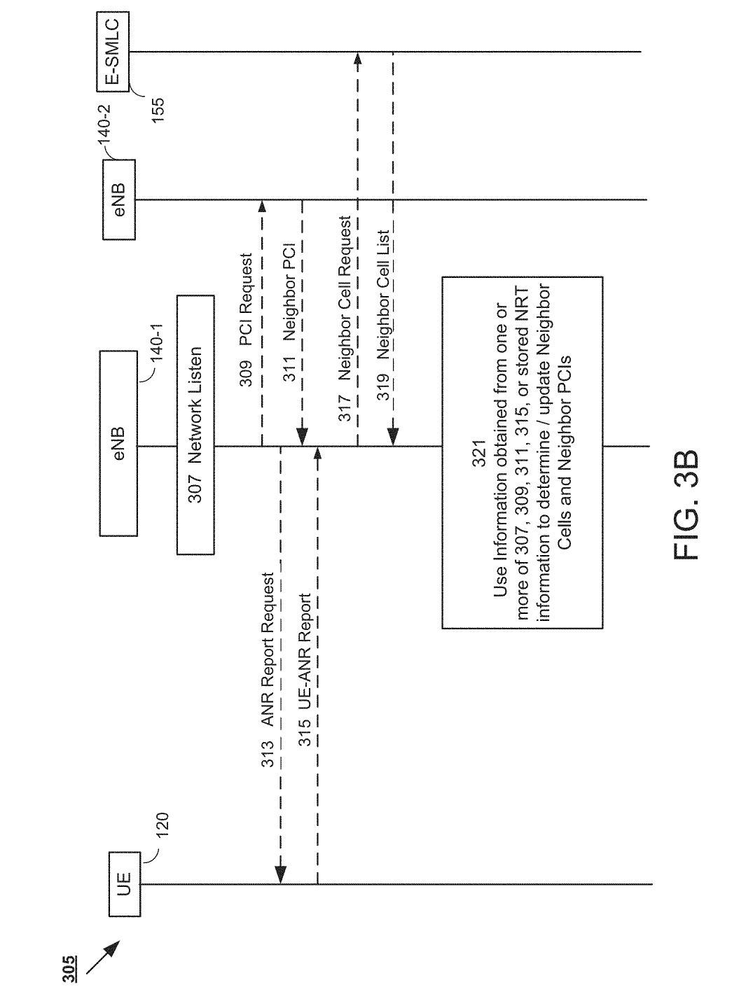

FIG. 3A shows a signaling flow diagram 300 illustrating entities and message flows for PCI configuration according to some disclosed embodiments. In FIG. 3A, for simplicity, only two TPs (TP 110-1 and TP 110-2) and one eNB (140-1) are shown. However, the message flows shown are also applicable to any other TPs 110 that may be coupled to eNB 140-1. Further, eNB 140-2 may be substituted for (or included in addition to) eNB 140-1.

In some embodiments, in block 305, eNB 140-1 may determine neighbor PCIs. For example, eNB 140-1 may determine the PCIs associated with any neighboring eNBs 140-j (j≠1). As one example, eNB 140-1 may determine PCIs associated with neighboring eNBs serving neighboring cells by performing a Network Listen function.

The Network Listen (NL) function may be performed by a base station (e.g. eNB 140-1). During NL, a base station (e.g. eNB 140-1) may “listen” to network transmissions on one or more frequencies. In some embodiments, the base station may stop or limit its own transmissions when performing NL. When “listening,” the base station (e.g. eNB 140-1) may scan and decode Master Information Blocks (MIBs) and System Information Blocks (SIBs) transmitted by neighboring cells (e.g. base stations such as eNBs 140-j associated with the neighboring cells) to determine, for each neighboring cell, one or more of a corresponding: PCI, CGI, Reference Signal Received Power (RSRP), Reference Signal Received Quality (RSRQ), RSSI, etc.

In some embodiments, eNB 140-1 may receive Available PCI List 320 from O&M 195. Available PCI List 320 may comprise a list of PCIs available to eNB 140-1. In some embodiments, Available PCI List 320 may be received prior to or during performance of block 305.

In block 325, eNB 140-1 may determine a set of available non-colliding PCIs from PCIs in Available PCI List 320. The term “non-colliding PCI” for a first eNB (e.g. eNB 140-1) is used to refer to a PCI that is associated with a PRS tone (or PRS frequency) that does not collide with a PRS tone associated with any neighbor eNB (e.g. eNBs 140-j, j≠1) of the first eNB. As outlined above, PRS tones are determined by PCI modulo 6 or mod (PCI, 6). Therefore, PCIₓ and PCI_{y} are non-colliding when mod (PCIₓ, 6)≠mod (PCI_{y}, 6). The term “available non-colliding PCI” for a first eNB (e.g. eNB 140-1) is used to refer to a PCI that is: (a) available for selection by the first eNB (e.g. eNB 140-1); and (b) is a non-colliding PCI. The term “colliding PCIs” is used to refer to PCIs with colliding PRS tones. In general, for a frequency re-use factor “r” (r≥2) based on a modulo function of the PCI value, two PCI values given by PCIₓ and PCI_{y} may be termed as colliding PCIs when mod (PCIₓ, r)=mod (PCI_{y}, r). Conversely, two PCI values given by PCIᵤ and PCIᵥ may be termed as non-colliding PCIs when mod (PCIᵤ, r)≠mod (PCIᵥ, r). For example, in LTE, where r=6 for macro cells, two PCI values, PCIₓ and PCI_{y} may be termed as colliding PCIs when mod (PCIₓ, 6)=mod (PCI_{y}, 6).

Further, the terms “colliding PRS” or “colliding PRS tones” or “colliding PRS frequencies” are used to refer to PRS from neighboring cells (e.g. eNBs 140-j) that are transmitted at the same frequency as a PRS transmitted by a first eNB (e.g. eNB 140-1). Conversely, the terms “non-colliding PRS” or “non-colliding PRS tones” or “non-colliding PRS frequencies” are used to refer to PRS from neighboring cells (e.g. eNBs 140-j) that are transmitted at a different frequency from a PRS transmitted by a first eNB (e.g. eNB 140-1).

In block 330, a PCI from the set of available non-colliding PCIs may be selected. For example, eNB 140-1 may select one of the available non-colliding PCIs as the PCI of the associated cell.

If the set of available non-colliding PCIs is empty, then, in some embodiments, an available PCI from Available PCI List 320 may be selected. For example, an available PCI in Available PCI List 320 that collides with the fewest number of neighbor PCIs may be selected.

As another example, when the set of available non-colliding PCIs is empty, then, in some embodiments, an available PCI from Available PCI List 320 may be selected based on one or more of the: RSSI, RSRP, or RSRQ of cells in Available PCI List 320. In some embodiments, an available PCI that collides with a neighboring cell with the lowest RSSI, lowest RSRP, or lowest RSRQ may be selected. A low RSSI, RSRP, or RSRQ may be associated with a weak signal. Therefore, selection of an available PCI that collides with a neighboring cell with the lowest RSSI, lowest RSRP, or lowest RSRQ may lead to lower interference when PRS signals (e.g. from eNB 140-1 and neighboring eNBs 140-j) are measured.

In some embodiments, when the set of available non-colliding PCIs is empty, then, in some embodiments, PCIs in Available PCI List 320 that collide with a PCI of a neighboring cell with which eNB 140-1 has a connection over an X2 interface 149 may be excluded from consideration when selecting a PCI for eNB 140-1. Connection over X2 interface 149 between eNB 140-1 and another eNB 140-j (j≠1) may be used as an indication of proximity of eNB 140-1 and eNB 140-j. Therefore, PCI collisions with eNBs 140-j connected to eNB 140-1 over X2 interface 149 may lead to greater PRS interference (e.g. due to the proximity of the cells). Accordingly, in some embodiments, (a) available PCI list 320 may be pruned to remove PCIs that collide with eNBs 140-j connected to eNB 140-1 over X2 interface 149; (b) the remaining PCIs (in the pruned PCI list) may then be selected based on: the number of collisions with neighboring PCIs, and/or based on one or more of the: RSSI, RSRP, or RSRQ. In some embodiments, some combination of the strategies outlined above may be used to select PCIs when set of available non-colliding PCIs is empty.

In some embodiments, the Selected PCI 335 may be transmitted or reported to O&M 195.

In some embodiments, PRS configuration parameters 340 may then be sent to TP 110-1 and TP 110-2. PRS configuration parameters 340 may configure TP 110-1 and 110-2 with PRS parameters for PRS transmission (e.g. may provide PRS bandwidth, carrier frequency, positioning occasions, muting pattern). In FIG. 3A above, because the likelihood of PRS collisions associated with the macro-cell (with which the TPs are associated) is decreased, the likelihood of PRS collisions between TPs of neighboring cells is also decreased when PRS transmission for TPs are varied based on a TP ID. For example, the likelihood of PRS collisions between TPs in neighboring cells with a common TP ID (e.g. a common physical antenna port ID) is decreased when their respective macro-cells have non-colliding PCIs. By facilitating non-colliding PCI selection, at the macro-cell level, disclosed embodiments also decrease the likelihood of PRS collisions between TPs associated with neighboring macro-cells. Further, in embodiments where PRS tones are based on modulo functions of TP IDs, the techniques described above for selection of PCIs may be used (e.g. by a controlling eNB 140) to assign non-colliding TP IDs to TPs 110 (e.g. TPs 110-1 and 110-2). In embodiments where PRS tones are based on modulo functions of TP IDs with a frequency re-use factor or “r” (r≥2), two TP ID values given by TP_IDᵤ and TP_IDᵥ may be termed as non-colliding TP IDs when mod (TP_IDᵤ, r)≠mod(TP_IDᵥ, r). Accordingly, in some embodiments, a controlling eNB may select from available non-colliding TP IDs when assigning TP IDs to TPs.

FIG. 3B shows a signal flow associated with block 305, illustrating entities and message flows to determine neighbor cells of an evolved NodeB (eNB) according to some disclosed embodiments. In FIG. 3B, one or more of: (a) transmission of PCI Request 309 and reception of Neighbor PCI 311; (b) transmission of ANR Report Request 313 and reception of UE-ANR Report 315; or (c) transmission of Neighbor Cell Request 313 and reception of Neighbor Cell List 315, may not occur. Further, the order of NL block 307; transmission of PCI Request 309 and reception of Neighbor PCI 311; transmission of ANR Request 313 and reception of UE-ANR 315; or transmission of Neighbor Cell Request 313 and reception of Neighbor Cell List 315 is merely exemplary and the sequence shown may be altered. For example, block 307 may occur after transmission of Neighbor Cell Request 313 and prior to reception Neighbor Cell List 315.

In block 307, PCIs associated with neighboring eNBs (e.g. eNB 140-2) serving neighboring cells may be determined by eNB 140-1 by performing a NL function. For example, a downlink receiver function or Network Listen Mode (NLM) may be invoked by eNB 140-1 to determine neighboring cells, neighbor eNBs and associated parameters such as PCIs, CGIs, RSRP, RSRQ, RSSI etc.

In some embodiments, optionally eNB 140-1 may send PCI request 309 to neighboring PCI eNB 140-2 over the X2 interface 149 or via MME 115 and/or Security Gateway 185. In general, an eNB 140 may send a PCI request to one or more neighboring eNBs (e.g. 140-2) over an X2 interface or via MME 115 and/or Security Gateway 185. PCI request 309 may specify information desired from eNB 140-2, which may include PCI information for eNB 140-2. In some embodiments, either in response to PCI Request 309, or separately as part of some other protocol, eNB 140-1 may receive PCI 311 associated with eNB 140-2 (or another neighboring eNB 140-j) over X2 interface 149 or via MME 115 and/or Security Gateway 185. In general, an eNB 140 may receive PCIs from one or more neighbors over an X2 interface or via MME 115 and/or Security Gateway 185.

In some embodiments, optionally eNB 140-1 may send ANR Report Request 313 to UE 120 over LTE Uu interface 125. In general, an eNB 140 may send am ANR Report request to one or more UEs 120 over the LTE Uu interface. ANR Report request 313 may specify measurements to be performed by UE 120 and request information, including PCIs associated with neighbor cells from UE 120. In some embodiments, in response to ANR Report Request 309, eNB 140-1 may receive UE-ANR Report 315 over the LTE Uu interface 125 from UE 120. UE-ANR Report 315 may include neighbor cell information, including PCIs associated with neighbor cells. In some embodiments, where ANR Report Requests 309 are sent to multiple UEs 120, eNB 140-1 may compile and/or aggregate the measurements and PCIs received in the plurality of received UE-ANR Reports 315. In some embodiments, the received measurements may be used to update stored neighbor cell information.

In some embodiments, optionally eNB 140-1 may send Neighbor Cell Request 317 to E-SMLC 155 via MME 115. The Neighbor Cell Request 317 may request information about neighbor cells including PCI information associated with neighbor cells. In some embodiments, in response to Neighbor Cell Request 317, eNB 140-1 may receive Neighbor Cell List 319, which may include PCI information for neighbor cells of eNB 140-1.

In block 321, eNB 140-1 may use information obtained from one or more of: (a) block 307; (b) UE-ANR Report 315; (c) Neighbor PCIs 309 received from eNBs; or (d) Neighbor Cell List 319 to determine a set of neighbors. In some embodiments, the set of neighbor cells and information pertaining to the neighbor cells including PCIs associated with the neighbor cells may be stored in a database and/or in a Neighbor Relations Table (NRT).

In some embodiments, a set of neighbors may be determined by eNB 140-1 based on stored information. In some embodiments, the set of neighbors may be determined based on the stored information when the stored information is recent (e.g. within some time window of a current time) or otherwise determined to be valid. In some embodiments, the stored information may comprise a NRT. The list of Neighboring PCIs determined by one or more of the methods above may be used in block 325 (FIG. 3A).

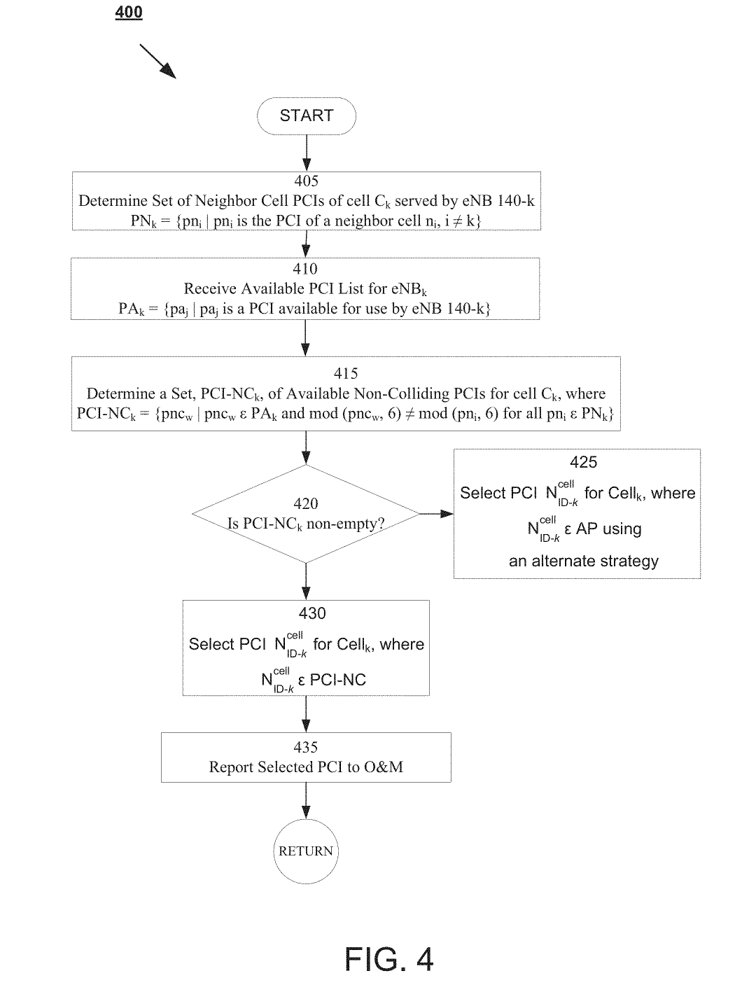

FIG. 4 shows a flowchart of an exemplary method 400 of selecting a PCI for an eNB. In some embodiments, method 400 may be performed by an eNB, which in FIG. 4 is denoted as eNB 140-k (k≥1). For example, for k=1, method 400 may be performed by eNB 140-1 when changes or reconfiguration occur on a network. A network change or network reconfiguration may occur when: (i) an eNB 140 is added to a network or comes back online after a shutdown; or (b) a neighboring eNB 104-i (i≠k) is removed from a network or stops functioning as a result of a fault or error; or (iii) PCIs are changed; or (iv) a PCI conflict or PCI confusion is detected (e.g. two neighboring cells/eNBs with the same PCI); or (iv) some combination of the above situations occurs. For example, method 400 may be performed by an eNB 140-k when it is added to a network or comes back online after a shutdown. As another example, method 400 may be performed by eNB 140-k, when a conflict is detected.

In some embodiments, method 400 may be performed by one or more eNBs 140-k in a SON to select PCIs. Method 400 may be performed as part of network self-configuration. For example, method 400 may be performed during network deployment, set-up, or during a pre-operational phase. In some embodiments, method 400 may be used for PCI planning and initial configuration. Further, method 400 may also be used for PCI optimization (e.g. during an operational phase). In some embodiments, method 400 may be used during fault recovery (e.g. when PCI conflicts are detected), maintenance (e.g. PCI reconfiguration), or self-healing (e.g. when an eNB 140 reboots or comes back online after recovering from a fault).

In block 405, a set, PNₖ, comprising PCIs of neighbor cells of a cell Cₖ served by an eNB 140-k may be determined. In some embodiments, the Neighbor PCI list PNₖ may correspond to Neighbor Cell List 319. In some embodiments, the Neighbor PCI list PNₖ may be obtained from one or more of: Neighbor Cell List 319, Neighbor PCIs 311 received from neighbor cells, UE-ANR Report 315, or an NRT. In some embodiments, the set of PCIs of neighbor cells, PNₖ, may be determined by eNB 140-k (e.g. eNB 140-1, for k=1) by: (a) performing a NL function to determine the PCIs of neighbor cells/eNBs; or (b) receiving PCIs of neighbor cells over the X2 interface; or (c) receiving PCIs of neighbor cells in a UE-ANR Report message (e.g. UE-ANR Report message 315) from a UE (e.g. UE 120); or (d) receiving PCIs of neighbor cells in a Neighbor Cell List (e.g. Neighbor Cell List 319) from a coupled E-SMLC (e.g. E-SMLC 155); or (e) from a database (e.g. an NRT) of previously stored neighbors of eNB 140-k; or (f) some combination of the above. In some embodiments, one or more of the message flows depicted in FIG. 3B may be used to determine PN. The set of PCIs of neighbor cells PNₖ may be written as:

PNₖ={pnᵢ|pnᵢ is the PCI of neighbor cell Nᵢ, i≠k} (2)

In block 410, an available PCI list, PAₖ, may be received. In some embodiments, the available PCI list PAₖ may correspond to Available PCI List 320. For example, eNB 140-k (e.g. eNB 140-1, for k=1) may receive an available PCI list from O&M (e.g. O&M 195). In some embodiments, the available PCI list, PAₖ, may include PCIs available for selection by eNB 140-k. The available PCI list, PAₖ, may be written as:

PAₖ={paₗ|paₗ is a PCI available for use eNB 140-k} (3)

In block 415, a set of available non-colliding PCIs for cell Cₖ, PCI-NCₖ, may be determined. For example, eNB 140-k may determine the set of available non-colliding PCIs, PCI-NCₖ. The set of available non-colliding PCIs for cell Cₖ, PCI-NCₖ, may be written as:

PCI-NCₖ={pnc_{w}|pnc_{w} ∈ PAₖ and mod(pnc_{w}, 6)≠mod(pnᵢ, 6) for all pnᵢ ∈ PNₖ} (4)

For example, in one embodiment, mod(pnᵢ, 6) may be determined for each pnᵢ ∈ PNₖ. Further, mod(paⱼ, 6) may be determined for each paₗ ∈ PAₖ and any PCI values in PAₖ for which mod(paₗ, 6)=mod(pnᵢ, 6) for some i, l may be removed from PAₖ to obtain PCI-NCₖ. Various other techniques may be used to obtain to obtain PCI-NCₖ.

In some embodiments, in block 420, it may be determined if PCI-NCₖ is non-empty. If PCI-NCₖ is non-empty (“Y” in block 420), then, in block 430, a PCI value N_{ID-k}^{cell} for cell Cₖ may be selected from one of the values in PCI-NCₖ (i.e. N_{ID-k}^{cell} ∈ PCI-NCₖ).

If PCI-NCₖ is empty (“N” in block 420), then, in block 425, an alternate strategy may be used to select a PCI value N_{ID-k}^{cell} for cell Cₖ. For example, when PCI-NCₖ is empty (PCI-NCₖ=ϕ)), a PCI value N_{ID-k}^{cell} for cell Cₖ may be selected from one of the values in PAₖ. For example, when PCI-NCₖ is empty, a PCI value paₗ in PAₖ that collides with the fewest number of values in PNₖ in may be selected as N_{ID-k}^{cell}.

As another example, when the set of available non-colliding PCIs PCI-NCₖ for cell Cₖ is empty, then, in some embodiments, an available PCI paₗ from Available PCI List PAₖ may be selected based on one or more of the corresponding RSSI, RSRP, or RSRQ of the cell(s) corresponding to paₗ. For example, cells Cₗ associated with PCI values paₗ in Available PCI List PAₖ may be determined. The PCI values in Available PCI List PAₖ may be sorted in increasing order of the RSSI, RSRP, or RSRQ of the corresponding cell Cₗ (e.g. as measured by eNB 140-k during NL). A PCI value paₗ associated with a cell Cₗ with the lowest RSSI, RSRP, or RSRQ may then be selected as N_{ID-k}^{cell} for cell Cₖ. A low RSSI, RSRP, or RSRQ may be associated with a weak signal. Therefore, selection of an available PCI that collides with a neighboring cell with lower RSSI, lower RSRP, or lower RSRQ may lead to lower interference when PRS signals are measured.

In some embodiments, when the set of available non-colliding PCIs is empty (PCI-NCₖ=ϕ)), then, in some embodiments, PCIs paₗ in Available PCI List PAₖ that collide with a PCI of a neighboring cell with which eNB 140-k has a connection over an X2 interface (e.g. X2 interface 149) may be excluded from consideration when selecting a PCI for eNB 140-k. For example, Available PCI List PAₖ may be pruned to obtain a pruned list PAₖ^{T} from which PCIs that collide with eNBs 140-i connected to eNB 140-1 over X2 interface 149 have been removed. A PCI in pruned list PAₖ^{T} may then be selected as N_{ID-k}^{cell}. In some embodiments, a PCI in pruned list PAₖ^{T} may be selected as N_{ID-k}^{cell} based on the number of collisions with neighboring PCIs, and/or based on one or more of the: RSSI, RSRP, or RSRQ. In some embodiments, some combination of the strategies outlined above may be used to select PCIs when set of available non-colliding PCIs is empty.

In block 435, the selected PCI N_{ID-k}^{cell} may be reported to O&M. For example, eNB 140k (e.g. eNB 140-1 for k=1) may report the selected PCI value to O&M 195.

In some embodiments, method 400 may further comprise, PRS configuration for TPs 110 associated with Cell Cₖ based on the selected PCI. For example, eNB 140-1 (for k=1) may send PRS configuration parameters (e.g. PRS configuration parameters 340) to TP 110-1 and TP 110-2. PRS configuration parameters may include PRS bandwidth, carrier frequency, positioning occasions, muting patterns etc. In method 400, because the likelihood of PRS collisions between the macro-cell (e.g. eNB 140-1 with which TP 110-1 and TP 110-2 are associated) and neighbor cells is decreased, the likelihood of PRS collisions between TPs of neighboring cells is also decreased. For example, for non-colliding macro cells, when PRS transmission for TPs associated with the respective macro cells are varied (from the PRS associated with a macro-cell) based on a TP ID, then collisions are less likely between the TPs of the non-colliding macro cells. Thus, by facilitating non-colliding PCI selection, at the macro-cell level, disclosed embodiments also decrease the likelihood of PRS collisions between TPs associated with neighboring macro-cells.

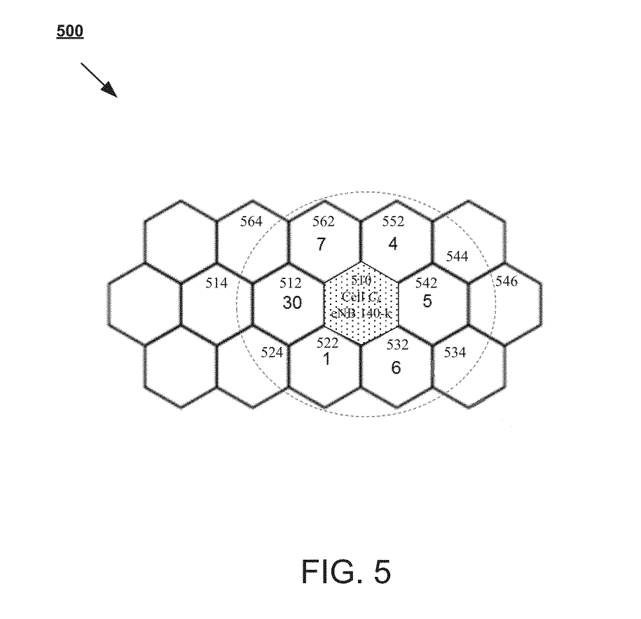

FIG. 5 shows an example 500 illustrating PCI selection for a cell identified as cell Cₖ 510 and served by eNB 140-k. In FIG. 5, cells 512, 522, 532, 542, 552, and 562 may be neighbor cells of cell Cₖ 510 because they share a boundary with cell Cₖ 510. As another example, both: (a) cells 512, 522, 532, 542, 552, and 562 (which share a boundary with cell Cₖ 510), and (b) cells 564, 514, and 524 (which do not share a boundary with Cell Cₖ 510) but are hearable by eNB 140-k (e.g. during Network Listen) and considered neighbors of cell Cₖ 510. As a further example, both: (a) cells 512, 522, 532, 542, 552, and 562 (which share a boundary with cell Cₖ 510), and (b) 514, 564, and 544 (which do not share a boundary with cell Cₖ 510) may be linked to cell Cₖ 510 by an X2 interface may be considered neighbors of cell Cₖ 510. As another example, both: (a) cells 512, 522, 532, 542, 552, and 562 (which share a boundary with cell Cₖ 510), and (b) cells 544, 546, and 534 (which do not share a boundary with cell Cₖ 510) may be reported in a UE-ANR message received by eNB 140-k and may be considered neighbors of Cellₖ 510. As a further example, both: (a) cells 512, 522, 532, 542, 552, and 562 (which share a boundary with cell Cₖ 510), and (b) cells 564, 514, 524, 544, 546, and 534 (which do not share a boundary with cell Cₖ 510) may be considered as neighbor cells based on a Neighbor Cell List (e.g. Neighbor Cell List 319) received by eNB 140-k from E-SMLC (e.g. E-SMLC 155). In some embodiments, the neighbor cells may be determined based on information (e.g. an NRT) stored by eNB 140-k and/or received from O&M (e.g. O&M 195). In general, as outlined above, neighbor cells may be determined by some combination of the above approaches. The cells listed as “neighbor cells” in the examples above are merely exemplary. In general, the list of neighbors may vary based on the technique(s) used to determine neighbors and/or environmental conditions (such as topology, locations of eNBs etc.).

For the purposes of the illustrative example below based on FIG. 5, cells 512, 522, 532, 542, 552, and 562 are considered as neighbors of cell Cₖ 510. As shown in FIG. 5, the set of PCIs of neighbor cells may be given by PNₖ={30, 1, 6, 5, 4, 7}.

Further, eNB 140-k may receive a set of available PCI values, PAₖ, where PAₖ={1, 7, 8, 10, 15, 18, 30}.

For PNₖ, the set of mod(pnᵢ, 6) values is M−PNₖ={0, 1, 0, 5, 4, 1}, while, for PAₖ, the set of values mod(paⱼ, 6) is M−PAₖ={1, 1, 2, 4, 3, 0, 0}.

Therefore, the set of available non-colliding PCI values PCI-NCₖ is given by PCI-NCₖ={8, 15} (because 8∈ PAₖ and mod(8,6)=2∉ M−PNₖ , and similarly, 15∈ PAₖ and mod(15,6)=3∉ M−PNₖ). In block 430, any one of the values in PCI-NCₖ={8, 15} may be selected as the PCI N_{ID k}^{cell} for Cellₖ 510.

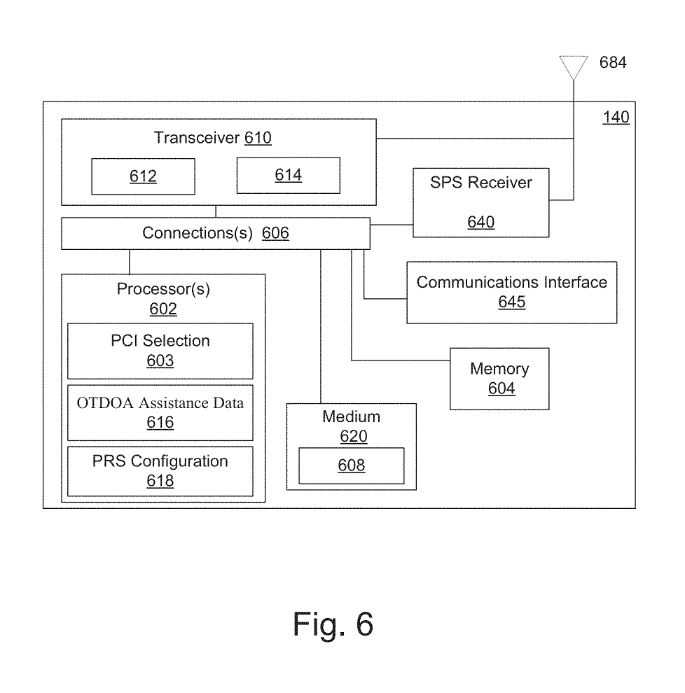

FIG. 6 shows a schematic block diagram illustrating certain exemplary features of an eNB 140 enabled to support PCI planning and selection. In some embodiments, eNB 140 may perform method 400. In some embodiments, eNB 140 may perform the eNB portion of message flows in FIGS. 3A and 3B.

In some embodiments, eNB 140 may, for example, include one or more processor(s) 602, memory 604, a transceiver 610 (e.g., wireless network interface), and (as applicable) an SPS receiver 640, which may be operatively coupled with one or more connections 606 (e.g., buses, lines, fibers, links, etc.) to non-transitory computer-readable medium 620 and memory 604. In certain example implementations, all or part of UE 120 may take the form of a chipset, and/or the like. The SPS receiver 640 may be enabled to receive signals associated with one or more SPS resources such as one or more Earth orbiting Space Vehicles (SVs) 180, which may be part of a satellite positioning system (SPS). SVs 180, for example, may be in a constellation of Global Navigation Satellite System (GNSS) such as the US Global Positioning System (GPS), the European Galileo system, the Russian Glonass system or the Chinese Compass or BeiDou system. In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, and/or various augmentation systems (e.g., an Satellite Based Augmentation System (SBAS)) that may be associated with or otherwise enabled for use with one or more global and/or regional navigation satellite systems.

By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS. In some embodiments, SPS receiver may receive GPS Clock and correction information to facilitate synchronization with other eNBs/TPCs 140. In some embodiments, clock synchronization/timing information may also be provided to TPs 110 by eNBs/TPCs 140 for PRS transmission.

Transceiver 610 may, for example, include a transmitter 612 enabled to transmit one or more signals over one or more types of wireless communication networks and a receiver 614 to receive one or more signals transmitted over the one or more types of wireless communication networks. For example, transceiver may transmit and receive LTE signal to/from UEs 120. Further, transceiver 610 may transmit and receive WLAN signals to one or more TPs 110. Transceiver 610 and/or communications interface 645 may also be used for communications with other eNBs (e.g. over the X2 interface) or MME (e.g. over the S1 interface).

Processor(s) 602 may be implemented using a combination of hardware, firmware, and software. In some embodiments, processor(s) 602 may provide appropriate eNB functionality. In some embodiments, processor(s) 602 and/or PCI selection processor 603 may perform method 400. In some embodiments, processor(s) 602 and/or PCI selection processor 603 may perform the eNB portion of message flows in FIGS. 3A and 3B.

In some embodiments, processor(s) 602 may provide appropriate functionality to configure TPs 110 with PRS transmission information, control TPs, and/or monitor TP 110 performance In some embodiments, processor(s) 602 may represent one or more circuits configurable to perform at least a portion of a data signal computing procedure or process related to the operation of eNB 140. In some embodiments, eNB 140 may be able to communicate with E-SMLC 155 and/or MME 115. In some embodiments, eNB 140 may also relay LPP messages between UE 120 and E-SMLC 155.

In some embodiments, processor(s) 602 may include OTDOA Assistance Data processor 616, which may process requests for OTDOA assistance information related to PRS configuration of eNB 140 and location information for eNB 140. In some embodiments, OTDOA Assistance Data processor 616 may also process requests for PRS configuration of TPS' 110 configured by eNB 140 and/or location information for TPS' 110 coupled to eNB 140.

In some embodiments, eNB 140 may include one or more antennas 684, which may be internal or external. Antennas 684 may be used to transmit and/or receive signals processed by transceiver 610 and/or SPS receiver 640. In some embodiments, MS antennas may be coupled to transceiver 610 and SPS receiver 640.

The methodologies described herein may be implemented by various means depending upon the application. For example, these methodologies may be implemented in hardware, firmware, software, or any combination thereof. For a hardware implementation, processor(s) 602, PCI Selection processor 603, OTDOA Assistance Data processor 616, PRS Configuration processor 618 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with microcode, procedures, functions, and so on that perform the functions described herein. Any machine-readable medium tangibly embodying instructions may be used in implementing the methodologies described herein. For example, software code may be stored in a non-transitory computer-readable medium 620 or memory 604 that is coupled to and executed by processor(s) 602. Memory may be implemented within the processor unit or external to the processor unit. As used herein, the term “memory” refers to any type of long term, short term, volatile, nonvolatile, or other memory and is not to be limited to any particular type of memory or number of memories, or type of media upon which memory is stored.

If implemented in firmware and/or software, the functions may also be stored as one or more instructions or program code 608 on a non-transitory computer-readable medium, such as medium 620 and/or memory 604. Examples include computer-readable media encoded with a data structure and computer-readable media encoded with a computer program 608. For example, the non-transitory computer-readable medium including program code 608 stored thereon may include program code 608 to support PCI planning and selection, SON deployment and configuration, provision of OTDOA assistance information to requesting entities including E-SMLC 155, support for LPP, LPPe, LPPa, PRS configuration, etc.

Non-transitory computer-readable media 620 includes physical computer storage media. A storage medium may be any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to store desired program code 608 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Memory 604 may represent any data storage mechanism. Memory 604 may include, for example, a primary memory and/or a secondary memory. Primary memory may include, for example, a random access memory, read only memory, etc. While illustrated in this example as being separate from processor(s) 602, it should be understood that all or part of a primary memory may be provided within or otherwise co-located/coupled with processor(s) 602. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer-readable medium 620. As such, in certain example implementations, the methods and/or apparatuses presented herein may take the form in whole or part of a computer-readable medium 620 that may include computer implementable instructions 608 stored thereon, which if executed by at least one processor(s) 602 may be operatively enabled to perform all or portions of the example operations as described herein. Computer readable medium 620 may be a part of memory 604.

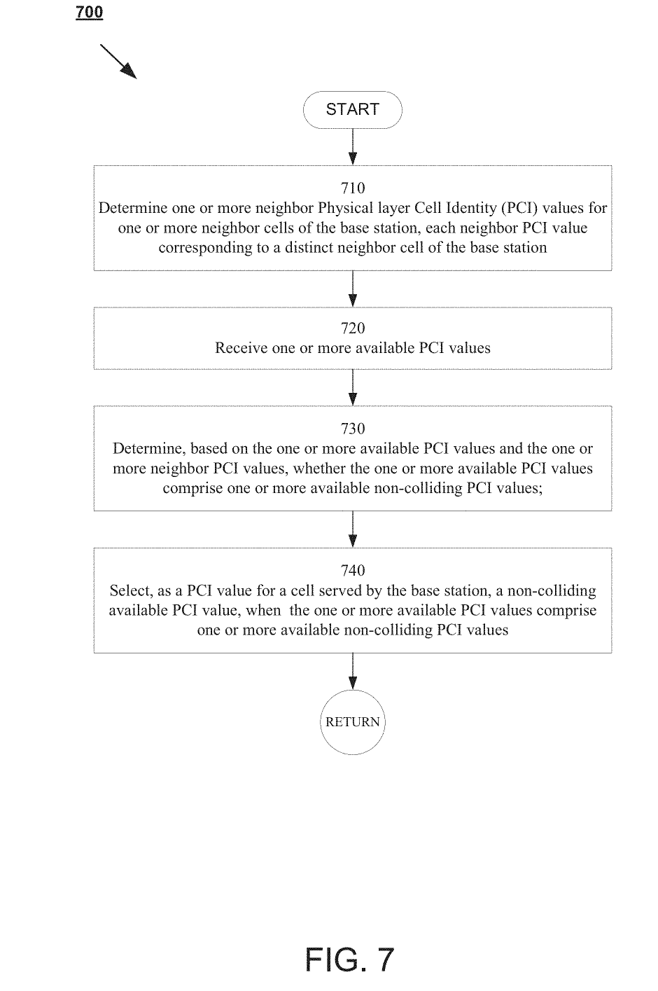

FIG. 7 shows a flowchart of an exemplary method 700 of selecting a PCI for an eNB. In some embodiments, method 700 may be performed by a base station (e.g. eNB 140). In some embodiments, the base station may take the form of an eNB (e.g. eNB 140) coupled to an LTE network. In some embodiments, method 700 may be performed upon: starting the base station; or adding the base station to a network; or reconfiguring the base station; or changing a PCI value associated with the base station; or changing at least one PCI value of the one or more neighbor PCI values; or a combination thereof. In some embodiments, method 700 may be performed by eNB (e.g. eNB 140), when a PCI conflict is detected.

In some embodiments, method 700 may be performed by one or more eNBs 140 in a SON to select PCIs. Method 700 may be performed as part of network self-configuration. For example, method 700 may be performed during network deployment, set-up, or during a pre-operational phase. In some embodiments, method 700 may be used for PCI planning and initial configuration. Further, method 700 may also be used for PCI optimization (e.g. during an operational phase). In some embodiments, method 400 may be used during fault recovery (e.g. when PCI conflicts are detected), maintenance (e.g. PCI reconfiguration), or self-healing (e.g. when an eNB 140 reboots or comes back online after recovering from a fault).

In block 710, one or more neighbor Physical layer Cell Identity (PCI) values for one or more neighbor cells of the base station may be determined, where each neighbor PCI value may correspond to a distinct neighbor cell of the base station. In some embodiments, in block 710, the one or more neighbor PCI values may be determined by performing a Network Listen function, wherein the one or more neighbor PCI values comprise PCI values detected during performance of the Network Listen function. In some embodiments, in block 710, the one or more neighbor PCI values may be determined by requesting, from a network entity, a neighbor cell list; and receiving, from the network entity, in response to the request, the neighbor cell list, wherein the neighbor cell list comprises the one or more neighbor PCI values. For example, the neighbor cell list may be received from a location server (e.g. an E-SMLC) communicatively coupled to the base station.

In some embodiments, in block 710, the one or more neighbor PCI values may be determined by: requesting, from a User Equipment (UE) communicatively coupled to the base station, an Automatic Neighbor Relations (ANR) report; receiving, from the UE in response to the request, a UE-ANR report; and determining, based on the UE-ANR report, the one or more neighbor PCI values. In some embodiments, in block 710, the one or more neighbor PCI values may be determined based on stored information, wherein the stored information comprises a Neighbor Relation Table (NRT).

In block 720, one or more available PCI values may be received. For example, the one or more available PCI values may be received from an Operations and Management (O&M) entity associated with the base station.

In block 730, based on the one or more available PCI values and the one or more neighbor PCI values, it may be determined whether the one or more available PCI values comprise one or more available non-colliding PCI values. The term “non-colliding PCI” for an eNB (e.g. eNB 140-1) is used to refer to a PCI that is associated with a PRS tone (or a PRS frequency) that does not collide with a PRS tone associated with any neighbor eNB (e.g. eNBs 140-j, j≠1) of the first eNB. PRS tones are determined as a function of PCI modulo 6 or mod (PCI, 6). Therefore, two PCIs, PCIₓ and PCI_{y} are non-colliding when mod (PCIₓ, 6)≠mod (PCI_{y}, 6). The term “available non-colliding PCI” for a first eNB (e.g. eNB 140-1) is used to refer to a PCI that is: (a) available for selection by the first eNB (e.g. eNB 140-1); and (b) is a non-colliding PCI.

For example, to determine whether the one or more available PCI values comprise the one or more available non-colliding PCI values, in block 730: for a reuse factor r, and for each neighbor PCI value PCI_Bₖ, it may be determined, for at least one available PCI value (PCI_Aⱼ), whether modulo (PCI_Aⱼ, r) is different from modulo (PCI_Bₖ, r) (i.e. modulo (PCI_Aⱼ, r)≠modulo (PCI_Bₖ, r)), where the one or more neighbor cells comprise N≥1 neighbor cells, and 1≤k≤N, and where the one or more available PCI values comprise M≥1 available PCI values, and 1≤j≤M.

In block 740, a PCI value for a cell served by the base station may be selected from a non-colliding available PCI value when the one or more available PCI values comprise one or more available non-colliding PCI values.

In some embodiments, method 700 may further comprise selecting the PCI value for the cell served by the base station from the one or more available PCI values when the one or more available PCI values do not comprise non-colliding PCI values.

In some embodiments, when the one or more available PCI values do not comprise non-colliding PCI values, the selected PCI value may be determined from the available PCI values based on one or more of: (a) Reference Signal Received Power (RSRP) values for a subset of the one or more neighbor cells, or (b) Reference Signal Received Quality (RSRQ) values for the subset of the one or more neighbor cells, or (c) Received Signal Strength Indication (RSSI) values for the subset of the one or more neighbor cells, where each neighbor cell in the subset is associated with a corresponding PCI value that collides with the selected PCI value. For example, the selected PCI value may collide with a PCI value of a neighbor cell in the subset, which has the lowest RSRP value, or RSRQ value, or RSSI value of neighbor cells in the subset. In some embodiments, the selected PCI value may collide with a PCI value of a neighbor cell in the subset, which has an RSRP value, or an RSRQ value, or an RSSI value that is below some corresponding designated or predetermined threshold.

In some embodiments, when the one or more available PCI values do not comprise non-colliding PCI values, the selected PCI value may be determined from the available PCI values based on the number of collisions between the selected PCI value and PCI values corresponding to the one or more neighbor cells. For example, the selected PCI value may collide with the fewest number of PCI values associated with neighbor cells in the subset.

In some embodiments, when the one or more available PCI values do not comprise non-colliding PCI values, the selected PCI value may be determined from the available PCI values based on the absence of an X2 interface between the subset of the one or more neighbor cells and the cell served by the base station. For example, the selected PCI value may collide with a PCI value associated with a neighbor cell that does not have an X2 interface with the base station or a cell served by the base station.

In some embodiments, the method may further comprise transmitting the selected PCI value to an Operations and Management (O&M) entity associated with the base station. In some embodiments, the method may further comprise configuring based on the selected PCI value, one or more Transmission Points (TPs) associated with the base station.

Although the present disclosure is described in connection with specific embodiments for instructional purposes, the disclosure is not limited thereto. Various adaptations and modifications may be made to the disclosure without departing from the scope. Therefore, the spirit and scope of the appended claims should not be limited to the foregoing description.

What is claimed is:

1. A processor-implemented method on a base station comprising:
determining one or more neighbor Physical layer Cell Identity (PCI) values for one or more neighbor cells of the base station, each neighbor PCI value corresponding to a distinct neighbor cell of the base station;
receiving one or more available PCI values;
determining, based on the one or more available PCI values and the one or more neighbor PCI values, whether the one or more available PCI values comprise one or more available non-colliding PCI values; and
selecting, as a PCI value for a cell served by the base station, a non-colliding available PCI value, when the one or more available PCI values comprise one or more available non-colliding PCI values.

2. The method of claim 1, wherein determining the one or more neighbor PCI values comprises:
performing a Network Listen function, wherein the one or more neighbor PCI values comprise PCI values detected during performance of the Network Listen function.

3. The method of claim 1, wherein determining the one or more neighbor PCI values comprises:
requesting, from a network entity, a neighbor cell list; and
receiving, from the network entity, in response to the request, the neighbor cell list, wherein the neighbor cell list comprises the one or more neighbor PCI values.

4. The method of claim 1, wherein determining the one or more neighbor PCI values comprises:
requesting, from a User Equipment (UE) communicatively coupled to the base station, an Automatic Neighbor Relations (ANR) report;
receiving, from the UE in response to the request, a UE-ANR report; and
determining, based on the UE-ANR report, the one or more neighbor PCI values.

5. The method of claim 1, wherein determining the one or more neighbor PCI values comprises:
determining the one or more neighbor PCI values based on stored information, the stored information comprising a Neighbor Relation Table (NRT).

6. The method of claim 1, further comprising:
selecting the PCI value for the cell served by the base station from the one or more available PCI values when the one or more available PCI values do not comprise non-colliding PCI values, wherein the selected PCI value is determined based on one or more of:
Reference Signal Received Power (RSRP) values for a subset of the one or more neighbor cells, or
Reference Signal Received Quality (RSRQ) values for the subset of the one or more neighbor cells, or
Received Signal Strength Indication (RSSI) values for the subset of the one or more neighbor cells,
wherein each neighbor cell in the subset is associated with a corresponding PCI value that collides with the selected PCI value.

7. The method of claim 1, further comprising:
selecting the PCI value for the cell served by the base station from the one or more available PCI values, when the one or more available PCI values do not comprise non-colliding PCI values, wherein the selected PCI value is determined based on:
a number of collisions between the selected PCI value and PCI values corresponding to the one or more neighbor cells.

8. The method of claim 1, further comprising:
selecting the PCI value for the cell served by the base station from the one or more available PCI values, when the one or more available PCI values do not comprise non-colliding PCI values, wherein the selected PCI value is determined based on:
an absence of an X2 interface between a subset of the one or more neighbor cells and the cell served by the base station, wherein each neighbor cell in the subset is associated with a corresponding PCI value that collides with the selected PCI value.

9. The method of claim 1, wherein determining whether the one or more available PCI values comprise the one or more available non-colliding PCI values comprises:
for a reuse factor r, for each neighbor PCI value PCI_Bₖ, determining, for at least one available PCI value (PCI_Aⱼ), whether modulo (PCI_Aⱼ, r)≠modulo (PCI_Bₖ, r), where the one or more neighbor cells comprise N≥1 neighbor cells, and 1≤k≤N, and where the one or more available PCI values comprise M≥1 available PCI values, and 1≤j≤M.

10. The method of claim 1, wherein receiving the one or more available PCI values comprises:
receiving the one or more available PCI values from an Operations and Management (O&M) entity associated with the base station.

11. The method of claim 1, further comprising:
transmitting the selected PCI value to an Operations and Management (O&M) entity associated with the base station.

12. A base station comprising:
a memory, and
a processor coupled to the memory, wherein the processor is configured to:
determine one or more neighbor Physical layer Cell Identity (PCI) values for one or more neighbor cells of the base station, each neighbor PCI value corresponding to a distinct neighbor cell of the base station;
receive one or more available PCI values;
determine, based on the one or more available PCI values and the one or more neighbor PCI values, whether the one or more available PCI values comprise one or more available non-colliding PCI values; and
select, as a PCI value for a cell served by the base station, a non-colliding available PCI value, when the one or more available PCI values comprise one or more available non-colliding PCI values.

13. The base station of claim 12, wherein to determine the one or more neighbor PCI values, the processor is configured to:
perform a Network Listen function, wherein the one or more neighbor PCI values comprise PCI values detected during performance of the Network Listen function.

14. The base station of claim 12, wherein to determine the one or more neighbor PCI values, the processor is configured to:
request, from a network entity, a neighbor cell list; and
receive, from the network entity, in response to the request, the neighbor cell list, wherein the neighbor cell list comprises the one or more neighbor PCI values.

15. The base station of claim 12, wherein to determine the one or more neighbor PCI values, the processor is configured to:
request, from a User Equipment (UE) communicatively coupled to the base station, an Automatic Neighbor Relations (ANR) report;
receive, from the UE in response to the request, a UE-ANR report; and
determine, based on the UE-ANR report, the one or more neighbor PCI values.

16. The base station of claim 12, wherein to determine the one or more neighbor PCI values, the processor is configured to:
determine the one or more neighbor PCI values based on stored information, the stored information comprising a Neighbor Relation Table (NRT).

17. The base station of claim 12, wherein the processor is further configured to:
select the PCI value for the cell served by the base station from the one or more available PCI values when the one or more available PCI values do not comprise non-colliding PCI values, wherein the selected PCI value is determined based on one or more of:
Reference Signal Received Power (RSRP) values for a subset of the one or more neighbor cells, or
Reference Signal Received Quality (RSRQ) values for the subset of the one or more neighbor cells, or
Received Signal Strength Indication (RSSI) values for the subset of the one or more neighbor cells,
wherein each neighbor cell in the subset is associated with a corresponding PCI value that collides with the selected PCI value.

18. The base station of claim 12, wherein the processor is further configured to:
select the PCI value for the cell served by the base station from the one or more available PCI values, when the one or more available PCI values do not comprise non-colliding PCI values, wherein the selected PCI value is determined based on:
a number of collisions between the selected PCI value and PCI values corresponding to the one or more neighbor cells.

19. The base station of claim 12, wherein the processor is further configured to:
select the PCI value for the cell served by the base station from the one or more available PCI values, when the one or more available PCI values do not comprise non-colliding PCI values, wherein the selected PCI value is determined based on:
an absence of an X2 interface between a subset of the one or more neighbor cells and the cell served by the base station, wherein each neighbor cell in the subset is associated with a corresponding PCI value that collides with the selected PCI value.

20. The base station of claim 12, wherein to receive the one or more available PCI values, the processor is configured to:
receive the one or more available PCI values from an Operations and Management (O&M) entity associated with the base station.

21. The base station of claim 12, wherein the base station is an eNodeB (eNB) coupled to a Long Term Evolution (LTE) cellular network.

22. The base station of claim 12, wherein to determine whether the one or more available PCI values comprise the one or more available non-colliding PCI values, the processor is configured to:
for a reuse factor r and for each neighbor PCI value PCI_Bₖ, determine, for at least one available PCI value (PCI_Aⱼ), whether modulo (PCI_Aⱼ, r)≠modulo (PCI_Bₖ, r), where the one or more neighbor cells comprise N≥1 neighbor cells, and 1≤k≤N, and where the one or more available PCI values comprise M≥1 available PCI values, and 1≤j≤M.

23. A base station comprising:
means for determining one or more neighbor Physical layer Cell Identity (PCI) values for one or more neighbor cells of the base station, each neighbor PCI value corresponding to a distinct neighbor cell of the base station;
means for receiving one or more available PCI values;
means for determining, based on the one or more available PCI values and the one or more neighbor PCI values, whether the one or more available PCI values comprise one or more available non-colliding PCI values; and
means for selecting, as a PCI value for a cell served by the base station, a non-colliding available PCI value, when the one or more available PCI values comprise one or more available non-colliding PCI values.

24. The base station of claim 23, wherein means for determining the one or more neighbor PCI values comprises:
means for performing a Network Listen function, wherein the one or more neighbor PCI values comprise PCI values detected during performance of the Network Listen function.

25. The base station of claim 23, wherein means for determining the one or more neighbor PCI values comprises:
means for requesting, from a User Equipment (UE) communicatively coupled to the base station, an Automatic Neighbor Relations (ANR) report;
means for receiving, from the UE in response to the request, a UE-ANR report; and
means for determining, based on the UE-ANR report, the one or more neighbor PCI values.

26. The base station of claim 23, wherein determining the one or more neighbor PCI values comprises:
determining the one or more neighbor PCI values based on stored information, the stored information comprising a Neighbor Relation Table (NRT).

27. A non-transitory computer-readable medium comprising executable instructions to configure a processor on a base station to:
determine one or more neighbor Physical layer Cell Identity (PCI) values for one or more neighbor cells of the base station, each neighbor PCI value corresponding to a distinct neighbor cell of the base station;
receive one or more available PCI values;
determine, based on the one or more available PCI values and the one or more neighbor PCI values, whether the one or more available PCI values comprise one or more available non-colliding PCI values; and
select, as a PCI value for a cell served by the base station, a non-colliding available PCI value, when the one or more available PCI values comprise one or more available non-colliding PCI values.

28. The computer-readable medium of claim 27, wherein to determine the one or more neighbor PCI values, the executable instructions configure the processor to:
perform a Network Listen function, wherein the one or more neighbor PCI values comprise PCI values detected during performance of the Network Listen function.

29. The computer-readable medium of claim 27, wherein to determine the one or more neighbor PCI values, the executable instructions configure the processor to:
request, from a User Equipment (UE) communicatively coupled to the base station, an Automatic Neighbor Relations (ANR) report;
receive, from the UE in response to the request, a UE-ANR report; and
determine, based on the UE-ANR report, the one or more neighbor PCI values.

30. The computer-readable medium of claim 27, wherein to determine the one or more neighbor PCI values, the executable instructions configure the processor to:
determine the one or more neighbor PCI values based on stored information, the stored information comprising a Neighbor Relation Table (NRT).
